(19) United States
(12) Patent Application Publication
(10) Pub. No.: US 2026/0031434 A1
(43) Pub. Date: Jan. 29, 2026

(54) TRACTION BATTERY PACK HANGING BARRIER

(71) Applicant: Ford Global Technologies, LLC, Dearborn, MI (US)

(72) Inventors: Patrick Roxin, Livonia, MI (US); Di Zhu, Novi, MI (US); Bhaskara Rao Boddakayala, Troy, MI (US); Joseph Polizzi, Chesterfield, MI (US); Gary J. Haddix, Monroe, MI (US); Eid Farha, Ypsilanti, MI (US)

(21) Appl. No.: 18/787,235

(22) Filed: Jul. 29, 2024

(51) Int. Cl. H01M 10/658; B60L 50/60; H01M 10/625; H01M 50/211; H01M 50/249; H01M 50/262

(52) U.S. Cl. CPC H01M 10/658; H01M 10/625; H01M 50/211; H01M 50/249; H01M 50/262; B60L 50/60; H01M 2220/20

(57) ABSTRACT

A traction battery pack assembly includes an enclosure, and a battery array within an interior of the enclosure. The battery array includes a plurality of battery cells. The assembly further includes a hanging barrier within the interior of the enclosure. The hanging barrier including an attachment flange that extends transversely from a hanging portion.

### TECHNICAL FIELD

This disclosure relates generally to barriers for a traction battery pack and, more particularly, to barriers that hang and can include a foam pad.

### BACKGROUND

A traction battery pack of an electrified vehicle can include groups of battery cells arranged in one or more cell stacks. The traction battery pack includes a plurality of battery cells and various other battery internal components that support electric vehicle propulsion. During a thermal event, battery cells can vent.

### SUMMARY

In some aspects, the techniques described herein relate to a traction battery pack assembly, including: an enclosure; a battery array within an interior of the enclosure, the battery array including a plurality of battery cells; and a hanging barrier within the interior of the enclosure, the hanging barrier including an attachment flange that extends transversely from a hanging portion.

In some aspects, the techniques described herein relate to an assembly, wherein the attachment flange is secured to an upwardly facing surface of the battery array.

In some aspects, the techniques described herein relate to an assembly, further including at least one push-in fastener securing the attachment flange to the upwardly facing surface of the battery array.

In some aspects, the techniques described herein relate to an assembly, wherein the hanging barrier is secured within the interior exclusively through the attachment flange.

In some aspects, the techniques described herein relate to an assembly, wherein the hanging portion is spaced from the battery array.

In some aspects, the techniques described herein relate to an assembly, wherein the hanging portion is spaced horizontally from the battery array.

In some aspects, the techniques described herein relate to an assembly, wherein the hanging portion is spaced from an endplate of the battery array.

In some aspects, the techniques described herein relate to an assembly, wherein hanging portion is disposed between a sidewall of the enclosure and an endplate of the battery array, wherein the hanging portion is spaced from both the sidewall and the endplate.

In some aspects, the techniques described herein relate to an assembly, wherein the hanging portion extends vertically from a vertically upper edge of the endplate to a vertically lower edge of the endplate.

In some aspects, the techniques described herein relate to an assembly, wherein the hanging portion includes a shield layer and a foam pad.

In some aspects, the techniques described herein relate to an assembly, wherein the shield layer and the attachment flange are portions of a sheet of material.

In some aspects, the techniques described herein relate to an assembly, wherein the sheet of material is a mica sheet of material.

In some aspects, the techniques described herein relate to an assembly, wherein the sheet of material has an L shape.

In some aspects, the techniques described herein relate to an assembly, wherein the attachment flange extends horizontally and shield layer extends vertically.

In some aspects, the techniques described herein relate to an assembly, wherein the foam pad includes an intumescent foam.

In some aspects, the techniques described herein relate to an assembly, wherein the foam pad includes a plurality of endothermic fillers.

In some aspects, the techniques described herein relate to an assembly, wherein the foam pad is adhesively secured to the shield layer.

In some aspects, the techniques described herein relate to an assembly, wherein the foam pad is disposed between the shield layer and an endplate of the battery array.

In some aspects, the techniques described herein relate to an assembly, wherein the battery array is a first battery array, and further including a plurality of second battery arrays within the enclosure, the plurality of second battery arrays each including at least one hanging barrier.

In some aspects, the techniques described herein relate to an assembly, wherein the hanging barrier is a hanging thermal barrier.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded view of a traction battery pack from the electrified vehicle of FIG. 1 according to an exemplary embodiment of the present disclosure

FIG. 3 illustrates a close-up, perspective view of a hanging barrier moving to an installed position within the traction battery pack of FIG. 2.

FIG. 4 illustrates a side view of the hanging barrier of FIG. 3 in an installed position where the hanging barrier is hanging from a battery array of the traction battery pack.

### DETAILED DESCRIPTION

This disclosure details exemplary barriers used within a traction battery assembly. In particular, the disclosure describes hanging barriers that can include a foam pad.

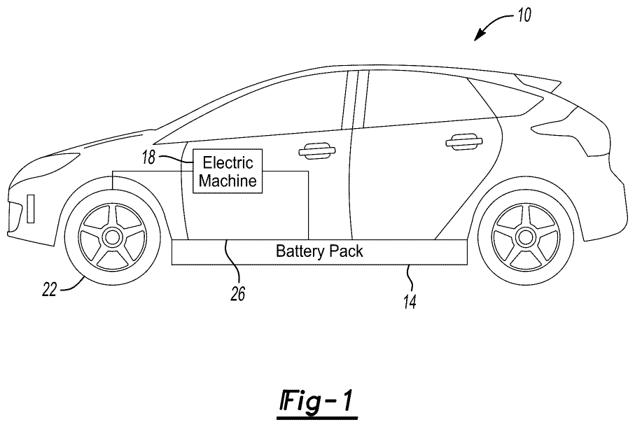

With reference to FIG. 1, an electrified vehicle 10 includes a battery pack 14, an electric machine 18, and wheels 22. The battery pack 14 powers the electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

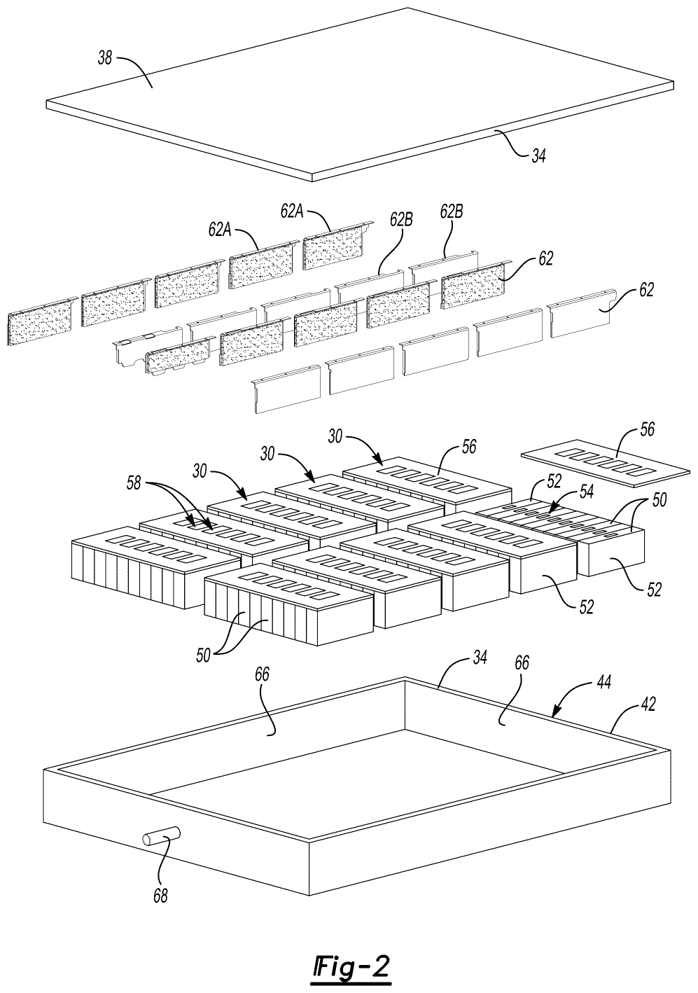

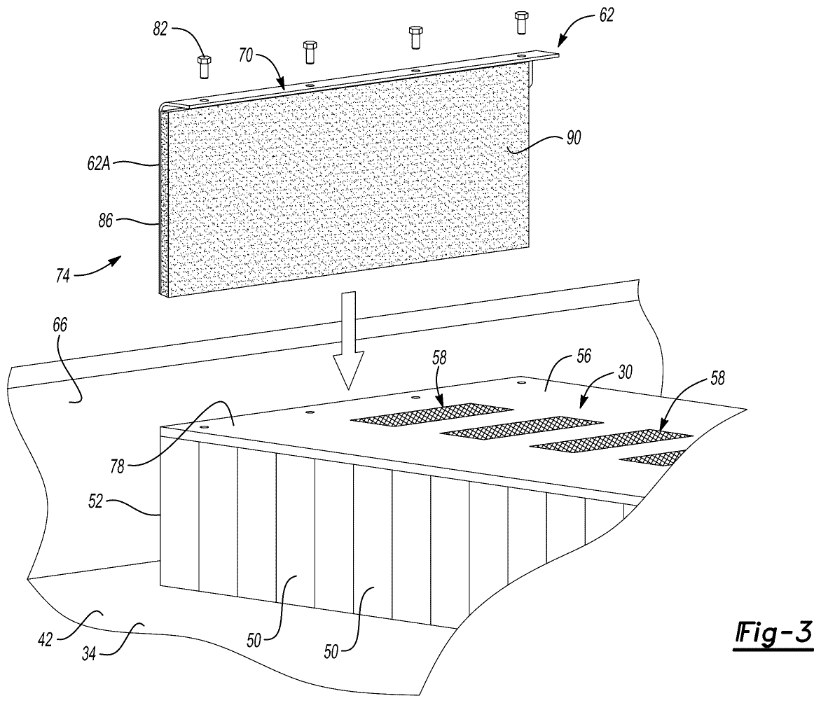

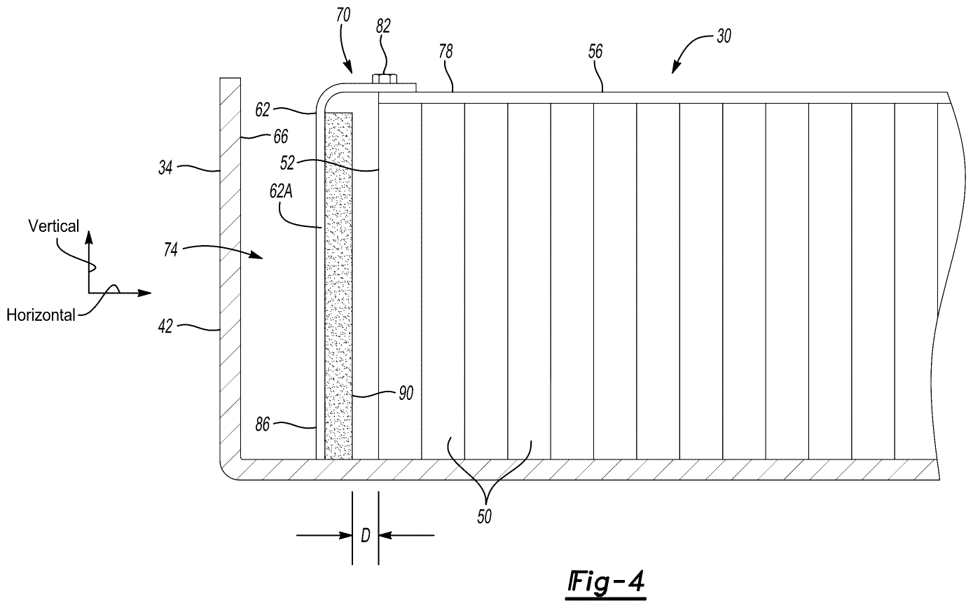

With reference now to FIGS. 2 to 4, the battery pack 14 includes a plurality of battery arrays 30 held within a battery pack enclosure 34. In the exemplary embodiment, the enclosure 34 includes an enclosure cover 38 and an enclosure tray 42. The enclosure cover 38 is secured to the enclosure tray 42 to provide an interior 44 that houses the battery arrays 30. The enclosure cover 38 can be secured to the enclosure tray 42 using mechanical fasteners, for example.

Each of the battery arrays 30 includes a plurality of battery cells 50 (or simply, “cells”) stacked side-by-side relative to each other along a respective cell stack axis AA and sandwiched between endplates 52.

The battery cells 50 store and supply electrical power. Although specific numbers of the battery arrays 30 and cells 50 are illustrated in the various figures of this disclosure, the battery pack 14 could include any number of the battery arrays 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

From time to time, pressure and thermal energy within one or more of the battery cells 50 in the battery pack 14 can increase. This can lead to the battery cells 50 expelling vent byproducts, which can include gas and debris.

The vent byproducts can be expelled from the associated battery cell 50 through a designated vent 54 within the housing of the battery cell 50, such as a membrane that yields in response to increased pressure, or through a ruptured area of the associated battery cell 50.

Each of the battery arrays 30, in this example, include a thermal shield 56 positioned atop the battery cells 50. The thermal shield 56 can be a mica thermal shield. The thermal shield 56 can include shield vents 58 that permit vent byproducts expelled through the vents 54 of one or more of the battery cells 50 to move vertically upward through the thermal shield into the interior 44. The shield vents 58 can include a screen or membrane.

Among other things, the thermal shield 56 blocks vent byproducts that have moved through the shield vents 58 in the thermal shields 56 from flowing directly adjacent to battery cells 50 that are not venting. This could increase thermal energy levels in the battery cells 50 that are not venting and potentially lead to those battery cells 50 venting.

A hanging barrier 62 is disposed at the axial ends of each battery array 30. The hanging barriers 62 can shield regions of the interior 44 from the vent byproducts released from battery cells 50. Some of the example hanging barriers 62A are positioned between endplates 52 of the battery arrays 30 and a sidewall 66 of the enclosure tray 42. These hanging barriers 62A can, for example, help to block particulates within the vent byproducts from impinging against the sidewall 66. Other hanging barriers 62B are disposed near a center of the battery pack between one of the endplates 52 and another hanging barrier 62B.

The thermal shields 56 and the hanging barriers 62 can shield certain areas within the interior 44 from the vent byproducts. The vent byproducts can eventually be discharged from the interior 44 through an enclosure vent 68 to an area surrounding the battery pack 14.

The hanging barriers 62 each include an attachment flange 70 extending transversely from a hanging portion 74. In the exemplary embodiment, the attachment flange 70 extends horizontally, and the hanging portion 74 extends vertically downward from the attachment flange 70. Horizontal and vertical are, for purposes of this disclosure, with reference to ground and general orientation of battery pack 14 when installed on the vehicle 10.

The hanging barrier 62 is considered a hanging barrier because the hanging barrier 62 is configured to be suspended from an associated one of the battery arrays 30 through the attachment flange 70 without being attached or supported elsewhere.

The hanging barriers 62 are supported, in this example, exclusively through the attachment flange 70 and a connection of the attachment flange 70 to an upwardly facing surface 78 of the associated array, which is, in this example, provided by one of the thermal shields 56. The attachment flange 70 can be connected to the upwardly facing surface 78 utilizing at least one push-in fasteners 82, such as a plurality of push-in rivets.

The hanging portion 74 can extend vertically from a vertically upper edge of the endplate to a vertically lower edge of the endplate. The hanging portion 74 of the hanging barrier includes, in this example, a shield layer 86 and a foam pad 90.

The attachment flange 70 and the shield layer 86 of the hanging portion 74 are different areas of the same sheet of material, which has an L shape. The sheet of material can be relatively rigid so that the attachment flange 70 can support the shield layer 86 and the foam pad 90 attached to the shield layer 86. The sheet of material providing the attachment flange 70 and the shield layer 86 can be a mica sheet of material.

The example attachment flange 70 is shown as a lip. Other types of attachment flanges could be utilized in other examples. For example, the attachment flange 70 could comprise a plurality of individual tabs extending horizontally from the hanging portion 74.

The foam pad 90 can be adhesively secured to the shield layer 86. The shield layer 86 supports the foam pad 90 in a position spaced outward a distance D away from the endplate 52 of the battery array 30.

The foam pad 90 can include an intumescent foam that expands in response to thermal energy levels reaching a threshold value, which can be associated with a venting event. Expansion of the foam pad 90 during the thermal event can help to fill gaps and other areas within the interior 44 and shield areas of the interior 44 from the vent byproducts V.

The foam pad 90 can instead or additionally include a plurality of endothermic fillers. During a thermal event, the endothermic fillers can help to suppress the thermal event by absorbing thermal energy.

During assembly of the battery pack 14, spacing the foam pad 90 the distance D from the endplate facilitates positioning the hanging barrier 62 within the interior 44.

In particular, during assembly, the battery arrays 30 can be positioned first within the interior 44 of the enclosure tray 42. Next, from above, an assembler can cause the hanging barrier 62 to be moved vertically downward toward an installed position. The distance D, which can be, for example, 6 mm or more, provides clearance for inserting the shield layer 86 and the foam pad 90. As the hanging barrier 62 is secured exclusively through the attachment flange 70, which is accessible from above the battery arrays 30, there is no need for the assembler to access areas further inside the enclosure tray 42 between the endplate 52 and the sidewall 66, which may be relatively difficult to access.

After positioning the hanging barrier 62 vertically, the push-in fasteners 82 are used to attach the attachment flange 70 and secure the hanging barrier 62. When secured, the foam pad 90 maintains the distance D from the endplate of the associated battery array 30 due to the relative rigid attachment flange 70 and shield layer 86.

After assembly, maintaining the distance D after assembly can help to reduce the likelihood of vibration issues associated with contact between the foam pad 90 and the endplate 52.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure;
a battery array within an interior of the enclosure, the battery array including a plurality of battery cells; and
a hanging barrier within the interior of the enclosure, the hanging barrier including an attachment flange that extends transversely from a hanging portion.

2. The assembly of claim 1, wherein the attachment flange is secured to an upwardly facing surface of the battery array.

3. The assembly of claim 2, further comprising at least one push-in fastener securing the attachment flange to the upwardly facing surface of the battery array.

4. The assembly of claim 2, wherein the hanging barrier is secured within the interior exclusively through the attachment flange.

5. The assembly of claim 1, wherein the hanging portion is spaced from the battery array.

6. The assembly of claim 1, wherein the hanging portion is spaced horizontally from the battery array.

7. The assembly of claim 1, wherein the hanging portion is spaced from an endplate of the battery array.

8. The assembly of claim 1, wherein hanging portion is disposed between a sidewall of the enclosure and an endplate of the battery array, wherein the hanging portion is spaced from both the sidewall and the endplate.

9. The assembly of claim 8, wherein the hanging portion extends vertically from a vertically upper edge of the endplate to a vertically lower edge of the endplate.

10. The assembly of claim 1, wherein the hanging portion comprises a shield layer and a foam pad.

11. The assembly of claim 10, wherein the shield layer and the attachment flange are portions of a sheet of material.

12. The assembly of claim 11, wherein the sheet of material is a mica sheet of material.

13. The assembly of claim 11, wherein the sheet of material has an L shape.

14. The assembly of claim 10, wherein the attachment flange extends horizontally and shield layer extends vertically.

15. The assembly of claim 10, wherein the foam pad comprises an intumescent foam.

16. The assembly of claim 10, wherein the foam pad comprises a plurality of endothermic fillers.

17. The assembly of claim 10, wherein the foam pad is adhesively secured to the shield layer.

18. The assembly of claim 10, wherein the foam pad is disposed between the shield layer and an endplate of the battery array.

19. The assembly of claim 1, wherein the battery array is a first battery array, and further comprising a plurality of second battery arrays within the enclosure, the plurality of second battery arrays each including at least one hanging barrier.

20. The assembly of claim 1, wherein the hanging barrier is a hanging thermal barrier.
